(19) United States
(12) Patent Application Publication
(10) Pub. No.: US 2007/0214382 A1
(43) Pub. Date: Sep. 13, 2007

(54) Portable terminal

(75) Inventor: Jun Sato, Kawasaki-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/393,433

(22) Filed: Mar. 30, 2006

(30) Foreign Application Priority Data
Mar. 9, 2006 (JP) 2006-064497

(51) Int. Cl. G06F 11/00

(52) U.S. Cl. 714/6

(57) ABSTRACT

A portable terminal which can reproduce downloaded contents to which a use condition is added, includes a time information acquisition section which acquires time information from an external device, a memory which memorizes the time information acquired by the time information acquisition section and contents by associating them, an update section which updates the time memorized in the memory to a time of reproducing the contents, when the contents are reproduced, a backup and restore section which transmits the downloaded contents to a backup device, and restores the backed up contents from the backup device. The backup and restore section memorizes backup time of the contents to the memory and transmits the contents and the backup time to the backup at backup, and compares the backup time the update time and prohibits restoration if the update time is later than the backup time at restoration.

### CROSS-REFERENCE TO RELATED APPLICATIONS

This application is based upon and claims the benefit of priority from prior Japanese Patent Application No. 2006-064497, filed Mar. 9, 2006, the entire contents of which are incorporated herein by reference.

### BACKGROUND OF THE INVENTION

1. Field of the Invention

The present invention relates to a portable terminal.

2. Description of the Related Art

In the standard scheme of the DRM (Digital Rights Management) standard specifications etc. specified by OMA (Open Mobile Alliance), a method of backing up encrypted contents and the rights information including the key to decrypt contents to an external device is specified. For example, the contents are encrypted by the AES (Advanced Encryption Standard) method by the content encryption key of 128 bits and delivered to a portable terminal according to the above-mentioned standard. The above-mentioned rights information contains permission information to use or to consume the contents, constraints information, and a content encryption key to decode contents. The rights information is protected by using the public key cryptosystem. The permission information is information that permits operations such as, for instance, “Contents may be reproduced”, “Contents may be executed”, and “Contents may be printed”. The restriction information is information used in combination with the permission information such as “How many times contents may reproduce in maximum”, “Contents may reproduce until what time”, and “Contents may be used for the period after originally reproducing it”, etc. Moreover, the rights is classified into two kinds of rights; Stateful rights which has to keep a state whenever the rights is used and Stateless rights that may not keep the state depending on the kind of restriction information. For instance, when “Reproduce” is set as the permission information, and “Three times is the maximum number of times of reproduction” is specified as the restriction information, the number of times of reproduction (Or, reproducible times of the remainder) should be kept with the portable terminal and be managed. Therefore, this rights is called as a Stateful rights. On the other hand, when, for instance, “Reproduce” is set as permission information, and the restriction information is not set especially and, it can reproduce infinitely. Therefore, this rights is called as a Stateless rights.

In the above-mentioned standard, the Stateless rights can be backed up to an external device (e.g., an external storage unit etc.) from the portable terminal. However, the backup to the external device is not permitted as for the Stateful rights. This reason is as follows. When the Stateful rights for which the state management is necessary is backed up to the external device, the state information should be backed up together as a natural result. However, if the state of various stages can be restored, the state cannot be substantially managed. As a result, such the replay attack cannot be prevented.

However, the user wants to back up the contents and the rights information regardless of the Stateful rights or the Stateless rights. When the backup (or, replication) to the external device is prohibited, the following problems are caused. For instance, when the user newly buys the portable terminal, and data should be transferred to a new portable terminal, the contents and the rights information from which the replication is forbidden cannot be transferred. In addition, the user cannot backup the contents in preparation for the data disappearance such as unexpected accidents etc.

Then, the technique for a rights user to prevent an illegal replication of the contents and to reproduce contents within the possible confines is proposed (See Japanese Patent Application KOKAI Publication No. 2004-48180). In this technique, first, the mobile station receives the contents protected by the copyrights from a contents delivery server. The mobile station transmits the backup file to a backup server with a telephone number of the mobile station. Then, the backup server associates the telephone number and the backup file and memorizes them. The mobile station requires the download of the backup file. Then, the backup server confirms the correspondence of the telephone number and the backup file. And, only when the telephone number of the mobile station which requires the download of the contents corresponds to the backup file, the backup server transmits the backup file to the mobile station.

However, at restoration, the following problems are caused when contents protected by the Stateful rights is backed up. For instance, in a Stateful rights which restricts the number of reproduction of the contents, the device manages the number of reproduction at that time. Here, an example of a case where three times reproducible Stateful rights is backed up will be explained. It is assumed that the backup is performed without reproducing the contents. At this time, the Stateful rights (three times reproducible rights) and contents are backed up. When the contents have been reproduced once, the Stateful rights was used once. Therefore, the reproducible number of contents managed with the device changes into two times. The backed up Stateful rights (three times reproducible rights) and the contents are restored thereafter. Then, a Stateful rights is overwritten and two reproducible times that is the number of reproduction and is managed with the terminal device is rewritten to three reproducible times. As a result, the number of reproduction of the contents becomes infinite. This is called a replay attack, and it is a problem at the backing-up of a Stateful rights.

### BRIEF SUMMARY OF THE INVENTION

An object of the present invention is to provide a portable terminal which can prevent a replay attack of contents protected by a Stateful rights.

A portable terminal which can reproduce downloaded contents to which a use condition is added, according to the present invention is characterized by comprising: a time information acquisition section which acquires time information from an external device; a memory which memorizes the time information acquired by the time information acquisition section and contents by associating them; an update section which updates the time memorized in the memory to a time of reproducing the contents, when the contents are reproduced; a backup and restore section which transmits the downloaded contents to a backup device, and restores the backed up contents from the backup device, in which the backup and restore section memorizes time information of a backup time to the memory by associating with the contents when the backup is performed, and transmits the contents and the time information of the backup time to the backup device by associating with the contents in a case of backing up the contents to the backup device, and compares the time information acquired from the backup device and the time information which is memorized to the memory, and prohibits restoration if the time information memorized in the memory is later than the time information acquired from the backup device in a case of restoring the contents from the backup device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a figure showing a schematic configuration of the contents management system according to the first embodiment of the present invention.

FIG. 2A and FIG. 2B are figures to explain an operation of the first embodiment of the present invention, FIG. 2A is a flowchart showing the flow of the backup processing, and FIG. 2B is a flowchart showing the flow of the restoration processing.

FIG. 3 is a figure showing a schematic configuration of the contents management system according to the second embodiment of the present invention.

### DETAILED DESCRIPTION OF THE INVENTION

An embodiment of the present invention will be described referring to the drawings.

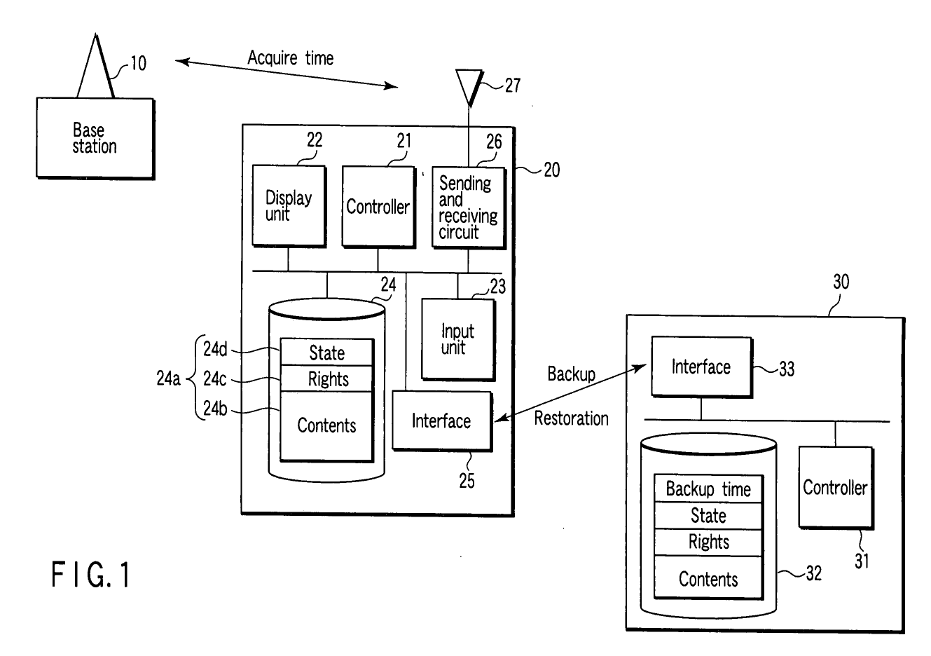

FIG. 1 shows a schematic configuration of the contents management system according to the first embodiment of the present invention. In FIG. 1, the contents management system has a base station 10, a portable terminal 20, and a backup device 30.

The base station 10 relays to enable the portable terminal 20 to perform the wireless communication with other portable terminals.

The portable terminal 20 is a terminal such as a mobile phone, or a PDA, and has a controller 21, a display unit 22, an input unit 23, a memory 24, an interface 25, a sending and receiving circuit 26, and an antenna 27. The portable terminal 20 communicates with other portable terminals through the base station 10, and downloads contents. The controller 21 executes the control of each part, the operation, and other processing. The display unit 22 has a display such as a liquid crystal displays (LCD) to display various information and images, etc. The input unit 23 is, for instance, a keypad to input information to the portable terminal 20. The memory 24 is a nonvolatile memory and a hard disk, etc. to memorize the contents etc. The interface 25 has, for instance, an USB interface and performs the communication between the portable terminal 20 and an external device (for instance, the backup device 30). The sending and receiving circuit 26 sends and receives information to/from the base station 10 through the antenna 27.

The backup device 30, for instance, has a controller 31, a memory 32, and an interface 33 and is served as an external storage device such as a memory and a hard disk of a personal computer (PC). The controller 31 executes a control of each part. The memory 32 has a hard disk for instance, and backs up the contents transmitted from the portable terminal 20. The interface 33 has an USB interface for instance, and communicates the backup device 30 and the portable terminal 20. The portable terminal 20 and the backup device 30 may be communicable bidirectional with wired USB connection and may be connected through LAN and the wireless LAN. The present invention is a technique concerning the backup of contents. Therefore, in the specification, a function concerning the backup of contents of the present invention will be mainly described among various functions of the base station 10, the portable terminal 20, and the backup device 30.

Contents 24b downloaded through the base station 10, rights 24c and state 24d are memorized to the portable terminal 20 as one set of data 24a (Hereafter, it might be called as a “contents file 24a” calling these generically) as shown in FIG. 1. Therefore, the rights 24c and the state 24d increase in proportion to the number of contents 12 if the contents the 24b become plural. The contents described in the specification means electronic contents such as music, electronic melody, animation, and electronic book specifically which can be downloaded by the portable terminal 20. Moreover, the contents 12 are encrypted with the contents key included in the rights 24c. The portable terminal 20 has a memory 24 to memorize the plurality of contents files 24a. The contents file 24a is memorized to the memory 24.

The rights 24c indicates a Stateful rights, and contains reproduction or play permission of the contents, the rights which is the restriction information thereof, and a contents key. The rights have permission and restriction information, for instance, up to three times reproducible. In the process to which the contents are downloaded, if a downloadable path is secured from the server that provides contents to the portable terminal 20 and neither falsification nor stealing a glance is generated when the contents is downloaded, it is unnecessary to encrypt the contents. The configuration that contents 12 in the state of the plaintext and the rights 24c are downloaded is acceptable.

The state 24d is information including updated date (time) and the number of reproduction of contents. “Update” contains the addition of the contents and the deletion of the contents besides the update of time by use of the contents.

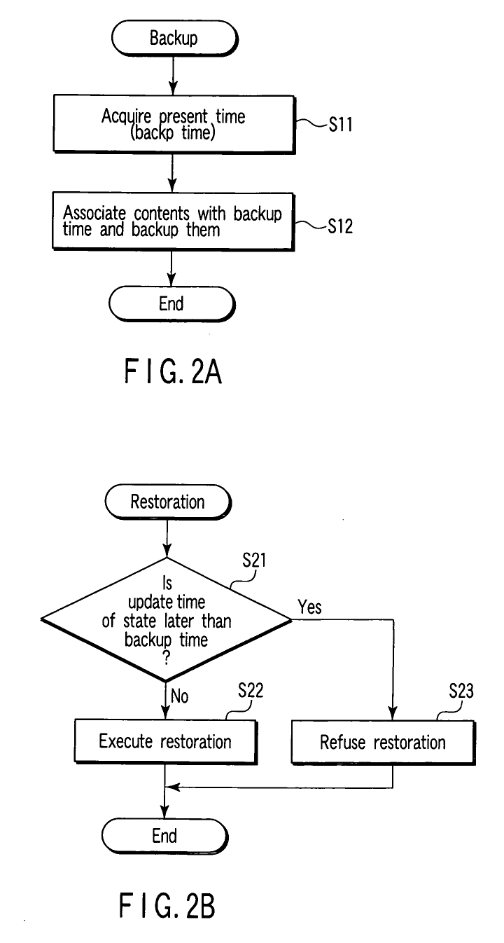

The operation in the first embodiment of the present invention will be described referring to FIG. 2A and FIG. 2B. FIG. 2A is a flowchart showing the flow of the backup processing. FIG. 2B is a flowchart showing the flow of the restoration processing. First, the flow of backup processing will be described.

The execution of the backup processing from the portable terminal 20 to the backup device 30 is started. Then, the portable terminal 20 acquires a present time from the base station 10 as a backup time (step S11). This time is not limited to be acquired from the base station 10. Any time is acceptable as a time which cannot be set with the portable terminal 20, that is, a time which can acquire from the external reliable time outside the portable terminal 20. For instance, a time signal from the base station which is used in a radio controlled watch and/or a time from a GPS are received, and the received time may be set to the backup time. Furthermore, the external reliable time may not be acquired at the time of each beginning of the backup. For instance, a clock that cannot be set by the user and be falsified in the portable terminal 20 is synchronized with the external reliable time periodically within a certain allowed period. As a result, the time acquired from a clock in the portable terminal 20 is considered as the time acquired from external and may be set to the backup time.

And, the contents file 24a and the backup time are associated with and recorded in the backup device 30 (step S12). If the contents 24b, the rights 24c and the state 24d in the contents file 24a are not encrypted, they are encrypted by the backup key generated in the portable terminal 20 and are backed up to the backup device. In addition, the backup time and the backup key associate with and are recorded in the portable terminal 20. When the plural times backups for the same contents file 24a are executed, a plurality of backup keys are maintained and the latest backup time is held at the same time.

If the contents are viewed and listened with the portable terminal 20 after the above-mentioned backup, the time of reproductioning the contents and the reproduction times after downloading contents are recorded in the portable terminal 20 as the state 24d. If the contents are not viewed and listened, the contents in the state 24d do not change.

Thereafter, if an available area of the internal storage of the portable terminal 20 should be expanded, the user deletes the contents 24b and the rights 24c from the internal storage and remains the state 24d and the backup key in the internal storage.

Next, in case of restoring the backed up contents file 24a, the update time (specifically, the last reproductioning time of the contents) in the state 24d and the backup time that is time when the contents file 24a was backed up are compared (step S21). Here, if the update time in the state 24d is earlier than or at the same time as the backup time, the contents file 24a has not been updated after backup, (Specifically, the contents 24b are not viewed and listened). Therefore, restoration is executed (step S22). If the update time in the state 24d is later than the backup time in step S21, it means that the contents 24b are viewed and listened after backup. Therefore, the restoration is refused (step S23). Since the contents are usually encrypted and are backed up, the contents are decoded with the backup key at restoration. In this case, the restoration can be refused by invalidating the backup key. Concretely, for instance, in a case that the backup time is 15:00 PM, Aug. 26, 2005, if the update time is 12:30 AM, Aug. 24, 2005, the contents 24b is not viewed and listened later than the backup time. Therefore, restoration is executed. However, if the update time is after 12:00 AM, Aug. 27, 2005, the contents 24b are viewed and listened later than the backup time. Therefore, restoration is not executed. The restoration is refused by invalidating or deleting the backup key held in the portable terminal 20 temporarily in that case. In addition, since the backed up contents cannot be appropriately decoded when the backup key is deleted, the restoration is refused. In the first embodiment, the time is exemplified by the unit of minute. However, if the unit is concerning time, any unit is acceptable. For instance, time may be compared by the unit of year, date, time and millisecond.

The replay attack of the contents protected by the Stateful rights can be prevented according to the first embodiment. In the first embodiment, when the contents 24b are viewed and listened with the portable terminal 20, it is preferable to acquire the external reliable time and is memorized in the state 24d as the viewing and listening time of the contents 24b.

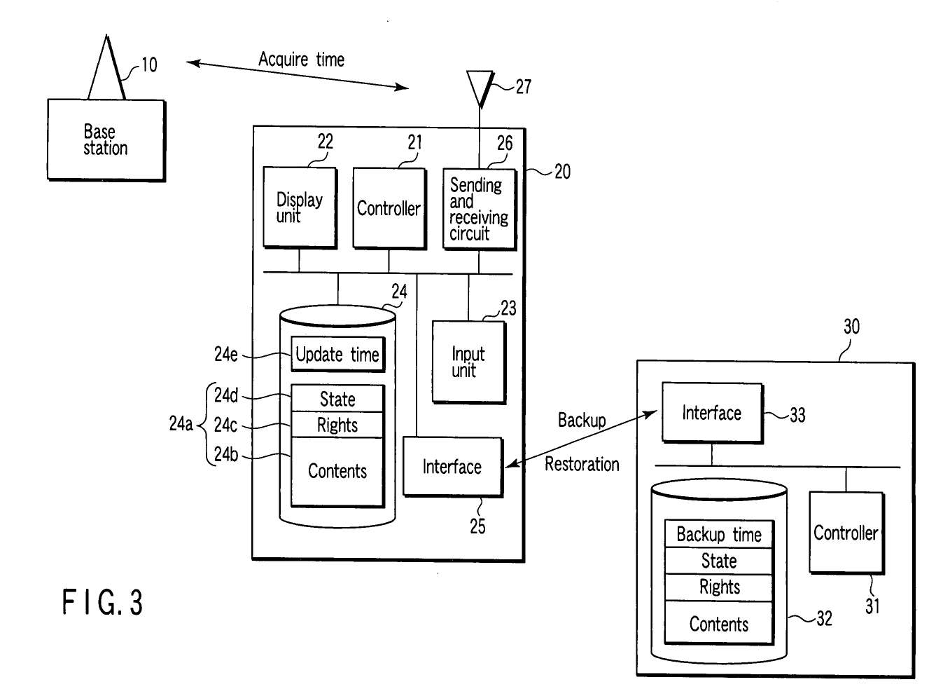

FIG. 3 shows a schematic configuration of the contents management system according to the second embodiment of the present invention. In FIG. 3, since a basic configuration is the same as that in FIG. 1, the overlapped explanation will be omitted. In FIG. 3, the same reference numerals are assigned to the same part as in FIG. 1.

A point where the second embodiment is different from the first embodiment is that an update time 24e is further added to the memory 24. The number of reproduction is recorded as updated information in the state 24d. Only time when the contents 24b were reproduced with the portable terminal 20 at last is managed as the update time 24e in the second embodiment besides the contents file 24a. Specifically, it is as follows.

The contents 24b, the rights 24c, and the state 24d downloaded through the base station 10 are memorized in the portable terminal 20 as the contents file 24a as shown in FIG. 3. Therefore, the rights 24c and the state 24d increase in proportion to the number of contents 12 if the contents 24b become plural. The contents described in the specification means electronic contents such as music, electronic melody, animation, and electronic book specifically which can be downloaded by the portable terminal 20. Moreover, the contents 12 are encrypted with the contents key included in the rights 24c. The portable terminal 20 has a memory 24 to memorize the plurality of contents files 24a. The contents file 24a is memorized to the memory 24.

The rights 24c indicates a Stateful rights, and contains view and listen permission of the contents, the rights which is the restriction information thereof, and a contents key. The rights has permission and restriction information for instance up to three times reproducible. In the process to which the contents are downloaded, if a downloading path is secured from the server that provides contents to the portable terminal 20 and neither falsification nor stealing a glance is generated when the contents is downloaded, it is unnecessary to encrypt the contents. The configuration that contents 12 in the state of the plaintext and the rights 24c are downloaded is acceptable.

The state 24d is information including updated date (time) and the number of reproduction of contents. “Update” means the addition of the contents and the deletion of the contents besides the update of time by use of the contents.

The update time 24e is a time when the contents are reproduced at last among times when the contents are viewed and listened. In the second embodiment, it is preferable that the update time is not a time of an internal clock of the portable terminal 20 and is set to a time acquired from the external and the deemed time thereof.

Since an operation of the second embodiment as configured above is almost similar to that of the first embodiment, drawings will be omitted. In the second embodiment, the update time is not memorized in each contents file 24a, but the time of reproductioning the contents at last is managed as the update time in a lump. Therefore, the backup time and the update time 24e are compared at restoration. Then, the restoration is refused if the update time 24e is later than the backup time. Since other operations are similar to the first embodiment, the explanation will be omitted.

The replay attack of the contents protected by the Stateful rights can be prevented by the above-mentioned configuration of the second embodiment as well as the first embodiment.

In the second embodiment, for instance, the backup time and the update time are used to judge the update. Whether the restoration can be executed or not by comparing the number of reproduction of the contents in the portable terminal 20 and the backed up state 24d.

According to the present invention, the replay attach of the contents protected by the Stateful rights can be prevented.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A portable terminal capable of reproducing downloaded contents to which a use condition is added, comprising:
a time information acquisition section which acquires time information from an external device;
a memory which memorizes the time information acquired by the time information acquisition section being associated with the contents;
an update section which updates the time memorized in the memory to a time of reproducing the contents, when the contents are reproduced;
a backup and restore section which transmits the downloaded contents to a backup device, and restores the backed up contents from the backup device, wherein
the backup and restore section
memorizes time information of a backup time to the memory being associated with the contents when the backup is performed, and transmits the contents and the time information of the backup time to the backup device being associated with the contents in a case of backing up the contents to the backup device, and
compares the time information acquired from the backup device and the time information which is memorized to the memory, and prohibits restoration if the time information memorized in the memory is later than the time information acquired from the backup device in a case of restoring the contents from the backup device.

2. The portable terminal according to claim 1, further comprising:
a key generator which generates an encryption key by using self-inherent information; and
an encryption section which encrypts the contents with the encryption key if the downloaded contents are not encrypted.

3. The portable terminal according to claim 2, wherein the backup and restore section invalidates the encryption key generated by the key generator when the restoration is prohibited.
